(19) United States
(12) Patent Application Publication
(10) Pub. No.: US 2025/0074233 A1
(43) Pub. Date: Mar. 6, 2025

(54) Power Supply Device, Vehicle, and Vehicle Infrastructure

(71) Applicant: Siemens Mobility Austria GmbH, Wien (AT)

(72) Inventors: Christoph FLOIS, Tulln an der Donau (AT); Georg HAVLICEK, Wien (AT); Christian SALIGER, Wien, Wien (AT)

(21) Appl. No.: 18/580,406

(22) PCT Filed: Jul. 14, 2022
(86) PCT No.: PCT/EP2022/069770

§ 371 Date: Jan. 18, 2024

(30) Foreign Application Priority Data
Jul. 19, 2021 (AT) A50598/2021

(51) Int. Cl. B60L 53/35; B60L 53/16

(52) U.S. Cl. CPC B60L 53/35; B60L 53/16; B60L 2200/18; B60L 2200/36

(57) ABSTRACT

A power supply device for a vehicle includes at least one contact head which can be connected to a vehicle and can be brought in contact with a docking station, wherein a contact head roll mechanism is rotatably connected to the at least one contact head and connected so as to be able to be brought in contact with the docking station, where the contact head roll mechanism includes at least two rolls or at least two rollers, via which a rolling contact can be established between the at least one contact head and the docking station, and where a first roll or a first roller is arranged on a first flank of the at least one contact head, and a second roll or a second roller is arranged on a second flank, located across the first flank, of the at least one contact head.

### CROSS-REFERENCE TO RELATED APPLICATIONS

This is a U.S. national stage of application No. PCT/EP2022/069770 filed 14 Jul. 2022. Priority is claimed on Austrian Application No. A50598/2021 filed 19 Jul. 2021, the content of which is incorporated herein by reference in its entirety.

### BACKGROUND OF THE INVENTION

### 1. Field of the Invention

The invention relates to a power supply device for a vehicle, in particular for a utility vehicle such as an electric bus or an electric heavy goods vehicle, with at least one contact head that can be connected to a vehicle and can be brought into contact with a stationary docking station to establish an electrical connection, where a contact head roll mechanism is rotatably connected to the at least one contact head and connected so as to be able to be brought into contact with the docking station, and where the contact head roll mechanism has at least two rolls or at least two rollers, via which a rolling contact can be established between the at least one contact head and the docking station.

### 2. Description of the Related Art

Power supply devices with contact heads can be brought into contact with stationary docking stations (e.g., contact hoods of charging columns). Electrical connections between the contact heads and the docking stations result in the contact heads being supplied with electricity. The contact heads are frequently connected to roofs of vehicles (e.g., electric buses or heavy goods vehicles) via rod systems, as a result of which current can be drawn via the docking stations and can be supplied to the vehicles via the rod systems. As a result, batteries or accumulators of the vehicles can, for example, be charged (for example, in a bus or heavy goods vehicle depot and/or at a bus stop).

Connection procedures between the contact heads and the docking stations may result in wear due to sliding contacts.

DE 10 2012 202 955 A1 discloses a charge current collector, via which an energy store of an electric vehicle can be charged up via current transmitted from a stationary charging station. A platform with electric contacts is coupled to a current collector rod system. The current collector rod system is connected to the vehicle.

However, DE 10 2012 202 955 A1 does not make clear how an electrical contact between the platform and a charging station is established or how the platform needs to be aligned for this to occur.

### SUMMARY OF THE INVENTION

It is an object of the invention is to provide a power supply device that is further developed in comparison to the prior art that permits particularly low-wear contacting of a docking station by a contact head.

This and other objects and advantages are achieved in accordance with the invention by a power supply device in which a first roll or a first roller is arranged on a first flank of the at least one contact head and a second roll or a second roller on a second flank, opposite the first flank, of the at least one contact head.

As a result, smooth guidance of the contact head in or on the docking station of a power transmission device (e.g., a charging station) is enabled. Components of the contact head and the docking station are prevented from sliding against one another. Linear guides that have to be heated can be dispensed with. Self-compensation of misalignments of the contact head occurs, as a result of which a precise alignment of the contact head in or on the docking station as well as secure electrical contacting of the docking station by the contact head are achieved. A long service life of the inventive power supply device can be anticipated. With this structure, it is further possible to dispense with a roll device in or on the docking station and a simple, robust and weather-resistant solution is achieved in respect of the rolling contact. In addition, owing to the presence of more than one roll or roller, a placement of the contact head onto the docking station, which is possible coming from different directions and, for example, also obliquely, is facilitated. Misalignments of the contact head can as a result be effectively compensated for. Furthermore, as a result, for example, an upper side of the contact head remains free for electrical first contacts, which can contact electrical second contacts of the docking station. No special recesses that must accommodate the rolls or rollers are necessary in the docking station, in order to reduce a distance between the contact head and the docking station or to enable an electrical contact between the contact head and the docking station.

It may be helpful if a docking roll device, with which the at least one contact head can be brought into contact, is rotatably connected to the docking station. The docking roll device can, for example, comprise rolls, with which the docking station is populated or lined in the contact area to the contact head, where the rolls can be concatenated, e.g., similarly to a conveyor belt. As a result, smooth rolling of the contact head in or on the docking station is facilitated.

An exact coupling between the contact head and the docking station is enabled if the docking station is formed as a contact hood, into which the at least one contact head can be introduced.

A preferred solution is achieved if a spring device, via which the at least one contact head can be connected to the vehicle, is connected to the at least one contact head. In this connection, it may be advantageous, for example, for reasons of space, if the spring device is connected to an underside or an upper side of the at least one contact head.

Additionally or alternatively, the spring device may be is connected laterally to the at least one contact head.

As a result of these measures, compensation for misalignments between the contact head and the docking station are facilitated. Due to spring forces of the spring device, the contact head can independently move into a position in or on the docking station that is advantageous for the power draw. The spring device also brings about a mechanical stabilization of the contact head.

If compensation for translatory misalignments between the contact head and the docking station is not necessary, then a simple and robust solution can also be achieved if the at least one contact head has a receiver for a ball joint, via which the at least one contact head can be connected to the vehicle, or the receiver is connected to the at least one contact head.

For example, a ball joint can be locked home into the receiver. Thus, rotatory misalignments between the contact head and the docking station can be compensated for via the ball joint.

In this connection, an exact fit of the ball joint in the receiver is enabled if the receiver is formed in the shape of a segment of a sphere.

Variable support of the contact head is achieved if a length-adjustable guide device, via which the at least one contact head can be connected to the vehicle, is connected in an articulated and sprung manner to the at least one contact head.

As a result, the contact head is prevented from remaining in a rotationally deflected position and it is ensured that the contact head returns to an upright position.

In a preferred embodiment, the at least one contact head is connected to a rod system, via which the at least one contact head can be connected to the vehicle, to form a current collector. In this connection, a high flexibility of the inventive power supply device in the compensation for translatory and/or rotational misalignments between the contact head and the docking station is achieved if the at least one contact head has at least three degrees of freedom of movement relative to the rod system.

Compensation for misalignments between the contact head and the docking station in all three directions of rotation and all three directions of translation is enabled if the at least one contact head is connected to a rod system, via which the at least one contact head can be connected to the vehicle, to form a current collector, where the at least one contact head has six degrees of freedom of movement relative to the rod system.

The objects and advantages are additionally achieved in accordance with the invention by a vehicle with an inventive power supply device.

The objects and advantages are further achieved in accordance with the invention by a vehicle infrastructure (for example, a charging station) with an inventive power supply device.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in greater detail below using exemplary embodiments, in which:

FIG. 1 shows a schematic side view of an exemplary first embodiment of an inventive power supply device with a first roll and a second roll on a front side of a contact head, which is in a first contact state with a docking station;

FIG. 2 shows a schematic side view of the exemplary first embodiment of an inventive power supply device in a second contact state;

FIG. 3 shows a schematic side view of an exemplary second embodiment of an inventive power supply device with a first roll, a second roll, a third roll and a fourth roll on a front side of a contact head, which contacts a docking station;

FIG. 4 shows a schematic side view of an exemplary third embodiment of an inventive power supply device with a docking station, whose internal contour is populated with rollers;

FIG. 5 shows a schematic side view of an exemplary fourth embodiment of an inventive power supply device, wherein a spring device is connected to an underside of a contact head and to a rod system;

FIG. 6: shows a schematic plan view of the exemplary fourth embodiment of an inventive power supply device in a sectional view;

FIG. 7 shows a schematic side view of an exemplary fifth embodiment of an inventive power supply device in a sectional view, where a spring device is connected to lateral surfaces of a contact head and to a rod system;

FIG. 8 shows a schematic plan view of the exemplary fifth embodiment of an inventive power supply device in a sectional view;

FIG. 9 shows a schematic side view of an exemplary sixth embodiment of an inventive power supply device in a sectional view, where a contact head is connected to a rod system via a ball joint and a spring device,

FIG. 10 shows a schematic sectional plan view of the exemplary sixth embodiment of an inventive power supply device;

FIG. 11 shows a schematic side view of an exemplary seventh embodiment of an inventive power supply device in a sectional view, where a contact head is connected to a vehicle via a ball joint and a rod system and via a guide device; and

FIG. 12: shows a schematic side view of exemplary embodiment of an electric vehicle and of a vehicle infrastructure, formed as a charging station, with an exemplary embodiment of an inventive power supply device.

### DETAILED DESCRIPTION OF THE EXEMPLARY EMBODIMENTS

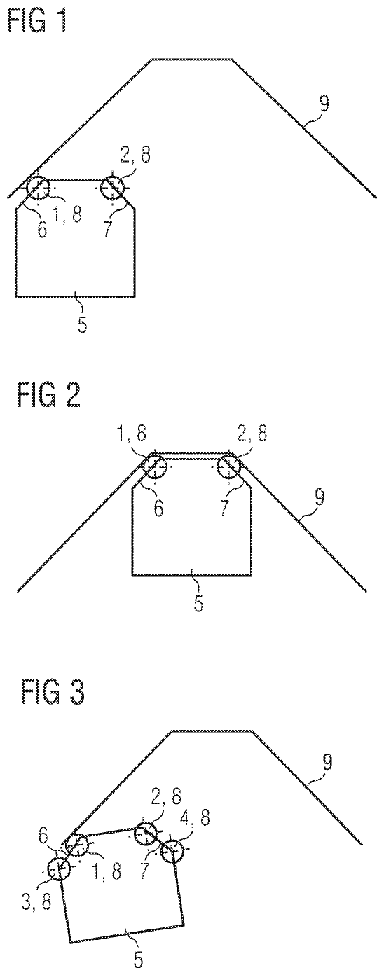

FIG. 1 shows a schematic side view of an exemplary first embodiment of an inventive power supply device with a first roll 1 and a second roll 2 on a front side of a contact head 5 of the power supply device, as well as two further rolls (not visible) on a rear side of the contact head 5. The contact head 5 has a trapezoidal upper part, upon whose chamfered surfaces a total of four rolls are arranged. The first roll 1 is, in this case, arranged on a chamfered first flank 6 of the contact head 5, and the second roll 2 is arranged on a chamfered second flank 7 of the contact head 5.

The first roll 1, the second roll 2 and the further rolls are rotatably connected to the contact head 5.

These four rolls form a contact head roll mechanism 8, via which the contact head 5 mechanically contacts a stationary docking station 9, formed as a contact hood, of the power supply device in the first contact state shown in FIG. 1. The docking station 9 is, as a counterpart to the contact head 5, formed in the shape of a hollow trapezoid. A rolling contact, via which the contact head 5 can be introduced into the docking station 9, is formed between the contact head 5 and the docking station 9 due to the contact head roll mechanism 8.

In accordance with the invention, it is also conceivable for the contact head roll mechanism 8, for example, to comprise rollers extending from the front side to the rear side of the contact head 5.

Starting from the first contact state, the contact head 5 can be introduced further into the docking station 9 or can roll into it, until a fit between the trapezoidal upper part of the contact head 5 and the hollow trapezoidal docking station 9 is formed. In this second contact state, which is illustrated in FIG. 2, an electrical connection is formed between the docking station 9 and the contact head 5 via contacts (not visible) of the contact head 5 and the docking station 9.

The contact head 5 is part of a charge current collector of a vehicle 10, with accumulators as an energy store, formed as an electric bus and shown in FIG. 12. The contact head 5 is, as shown in FIG. 12, connected to the vehicle 10 via a rod system 11. The docking station 9 is part of a vehicle infrastructure 12, configured as a charging station, which is likewise illustrated in FIG. 12.

In the second contact state, the accumulators of the vehicle 10 are charged up via the vehicle infrastructure 12 due to the electrical connection between the contact head 5 and the docking station 9.

FIG. 2 illustrates a schematic side view of the exemplary first embodiment of an inventive power supply device, which is also shown in FIG. 1. Hence, the same reference characters are used in FIG. 2 as in FIG. 1.

Unlike in FIG. 1, in which a first contact state between a contact head 5 and a docking station 9 is disclosed, FIG. 2 shows a second contact state, in which the contact head 5, fitting precisely to an internal contour of the docking station 9, is fully introduced into the docking station 9. As a result, an electrical connection is formed between the contact head 5 and the docking station 9.

FIG. 3 discloses a schematic side view of an exemplary second embodiment of an inventive power supply device, which resembles the first embodiment of an inventive power supply facility that is shown in FIG. 1 and FIG. 2. Hence, some of the same reference characters are used in FIG. 3 as in FIG. 1 and FIG. 2.

Unlike in FIG. 1 and FIG. 2, the power supply device in accordance with FIG. 3 comprises a contact head 5 with a contact head roll mechanism 8, which on a front side of the contact head 5 has a first roll 1, a second roll 2, a third roll 3 and a fourth roll 4 and on a rear side of the contact head 5 a further four rolls, which are not visible in FIG. 3, which are rotatably connected to the contact head 5.

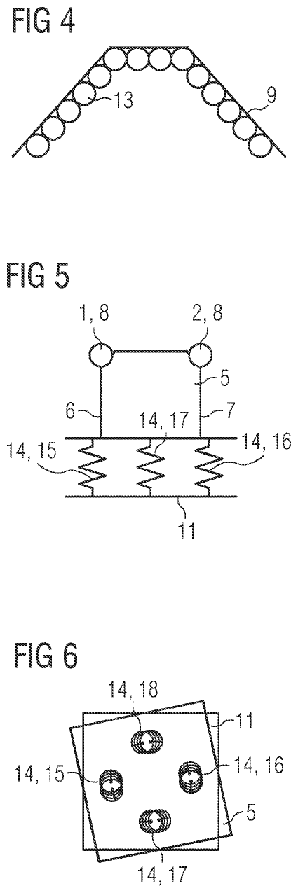

FIG. 4 shows a schematic side view of an exemplary third embodiment of an inventive power supply device with a docking station 9, whose internal contour is populated with rollers. These rollers are rotatably connected to the docking station 9 and form a docking roll device 13, via which the docking station 9, for example, can be mechanically and electrically contacted by a current collector contact head of an electric vehicle.

FIG. 5 discloses a schematic side view of an exemplary fourth embodiment of an inventive power supply device with a contact head 5. The contact head 5 is formed structurally and functionally similar to the exemplary first embodiment of an inventive power supply device which is shown in FIG. 1 and can be brought into mechanical and electrical contact with a docking station 9, as shown, for example, in FIG. 1, via a contact head roll mechanism 8.

A first roll 1 of the contact head roll mechanism 8 is arranged in an upper area of a first flank 6 of the contact head 5, and a second roll 2 of the contact head roll mechanism 8 is arranged in an upper area of a second flank 7 of the contact head 5.

A spring device 14, which has a first spring 15, a second spring 16, a third spring 17 and a fourth spring 18 visible in FIG. 6, which are formed as helical springs, is connected to an underside of the contact head 5 and to a rod system 11 of a charge current collector of a vehicle 10, as is illustrated by way of example in FIG. 12.

The first spring 15, the second spring 16, the third spring 17 and the fourth spring 18 form a sprung four-point support of the contact head 5 on the rod system 11. Due to the spring device 14, the contact head 5 has three translatory and three rotational degrees of freedom of movement relative to the rod system 11. Movements of the contact head 5 can be reset via the spring device 14.

FIG. 6 shows a schematic plan view of the exemplary fourth embodiment of an inventive power supply device, which is also illustrated in FIG. 5, in a sectional view.

A contact head 5 is connected to a rod system 11 of a charge current collector via a spring device 14, which has a first spring 15, a second spring 16, a third spring 17 and a fourth spring 18. FIG. 6 shows a state of the contact head 5 that is rotated relative to the rod system 11 about an axis appearing projected in FIG. 6.

Due to the spring device 14, the contact head 5 can also be deflected in a translatory manner relative to the rod system 11 in the image plane of FIG. 6 and perpendicular to the image plane. Furthermore, rotational deflections of the contact head 5 relative to the rod system 11 about axes in the image plane and about axes appearing projected in FIG. 6 are also possible.

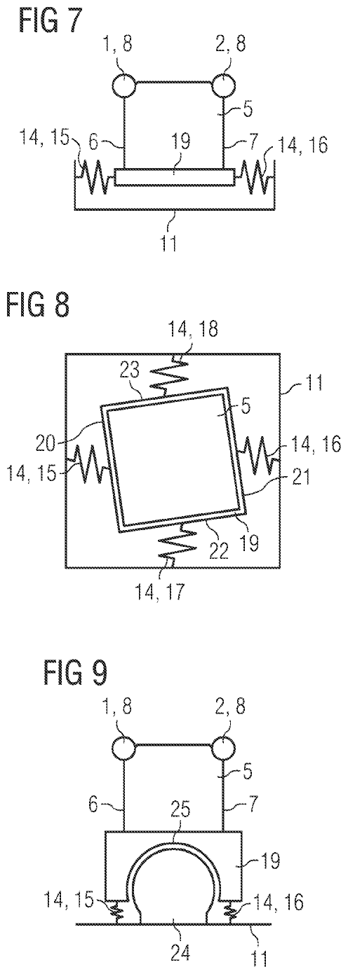

FIG. 7 discloses a schematic sectional view side view of an exemplary fifth embodiment of an inventive power supply device with a contact head 5. The contact head 5 is formed structurally and functionally similar to the exemplary first embodiment of an inventive power supply device that is shown in FIG. 1 and can be brought into mechanical and electrical contact with a docking station 9, as is shown, for example, in FIG. 1, via a contact head roll mechanism 8.

A first roll 1 of the contact head roll mechanism 8 is arranged in an upper area of a first flank 6 of the contact head 5, and a second roll 2 of the contact head roll mechanism 8 is arranged in an upper area of a second flank 7 of the contact head 5.

Arranged laterally to the contact head 5 is a spring device 14, which has a first spring 15, a second spring 16, a third spring 17 visible in FIG. 8 and a fourth spring 18 likewise visible in FIG. 8.

The first spring 15, the second spring 16, the third spring 17 and the fourth spring 18 are coupled to lateral surfaces of a base plate 19 connected to the contact head 5 and are aligned horizontally in the deflection state shown in FIG. 7.

The spring device 14 is further connected to a rod system 11 of a charge current collector of a vehicle 10, as illustrated by way of example in FIG. 12.

The first spring 15, the second spring 16, the third spring 17 and the fourth spring 18, which are configured as helical springs, form a four-point connection of the contact head 5 to the rod system 11.

Due to the spring device 14, the contact head 5 has three translatory and three rotational degrees of freedom of movement relative to the rod system 11. Movements of the contact head 5 can be reset via the spring device 14.

FIG. 8 shows a schematic plan view of the exemplary fifth embodiment of an inventive power supply device, which is also illustrated in FIG. 7, in a sectional view.

A contact head 5 is connected to a rod system 11 of a charge current collector via a spring device 14, which has a first spring 15, a second spring 16, a third spring 17 and a fourth spring 18. The contact head 5 is arranged on a square base plate 19. The first spring 15 is connected to a first lateral surface 20 of the base plate 19, the second spring 16 is connected to a second lateral surface 21 of the base plate 19, the third spring 17 is connected to a third lateral surface 22 of the base plate 19 and the fourth spring 18 is connected to a fourth lateral surface 23 of the base plate 19.

FIG. 8 shows a state of the contact head 5 that is rotated about an axis appearing projected in FIG. 8 relative to the rod system 11.

Due to the spring device 14, the contact head 5 can also be deflected relative to the rod system 11 in a translatory manner in the image plane of FIG. 8 and perpendicular to the image plane. Furthermore, rotational deflections of the contact head 5 relative to the rod system 11 about axes in the image plane and about axes appearing projected in FIG. 8 are also possible.

FIG. 9 illustrates a schematic sectional view side view of an exemplary sixth embodiment of an inventive power supply device.

The power supply device can be employed in an electric vehicle 10, as shown for example in FIG. 12, and comprises a contact head 5. The contact head 5 can be introduced into a docking station 9, as shown for example in FIG. 1, via a contact head roll mechanism 8.

A first roll 1 of the contact head roll mechanism 8 is arranged in an upper area of a first flank 6 of the contact head 5, and a second roll 2 of the contact head roll mechanism 8 is arranged in an upper area of a second flank 7 of the contact head 5.

The contact head 5 is connected to a rod system 11 of a charge current collector, as is disclosed by way of example in FIG. 12, via a ball joint 24 and a spring device 14.

The contact head 5 is arranged on a base plate 19 and is connected thereto. The base plate 19 has on its underside a receiver 25, formed as a recess in the shape of a segment of a sphere, for the ball joint 24, into which the ball joint 24 is introduced.

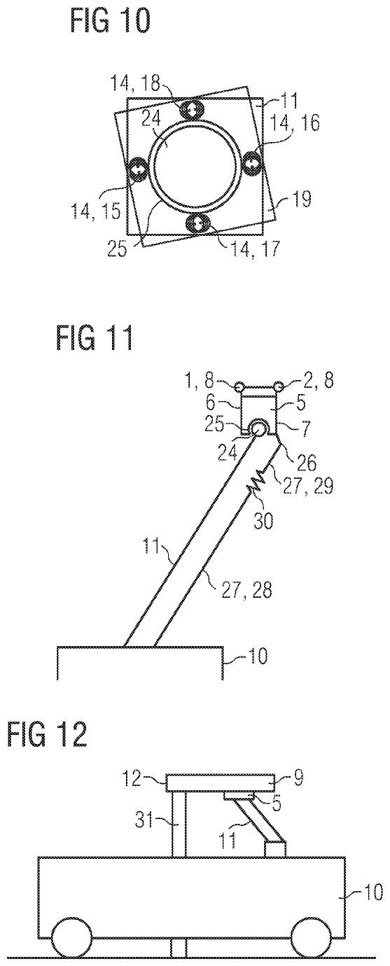

Likewise, arranged on the underside of the base plate 19 is the spring device 14, which comprises a first spring 15, a second spring 16 and, visible in FIG. 10, a third spring 17 and a fourth spring 18. The first spring 15, the second spring 16, the third spring 17 and the fourth spring 18 are formed as helical springs. The first spring 15 is arranged to the left of the ball joint 24, and the second spring 16 is arranged to the right of the ball joint 24. The third spring 17 is arranged in front of the ball joint 24, and the fourth spring 18 is behind the ball joint 24.

Due to its connection to the rod system 11 via the base plate 19 and the ball joint 24, the contact head 5 has three rotational degrees of freedom relative to the rod system 11. The spring device 14 enables rotational deflections of the contact head 5 from its neutral position to be reset.

FIG. 10 discloses a schematic plan view of the exemplary sixth embodiment of an inventive power supply device, which is also shown in FIG. 9, in a sectional view. Hence, some of the same reference characters are used in FIG. 10 as in FIG. 9.

A contact head 5 visible in FIG. 9 is connected to a rod system 11 of a charge current collector, as is shown by way of example in FIG. 12, via a base plate 19, a ball joint 24 and a spring device 14, which comprises a first spring 15, a second spring 16, a third spring 17 and a fourth spring 18.

In the deflection state relative to the rod system 11 shown in FIG. 10, the contact head 5 is rotated about an axis appearing projected in FIG. 10.

FIG. 11 illustrates a schematic side view of an exemplary seventh embodiment of an inventive power supply device in a sectional view, which resembles the exemplary sixth embodiment of an inventive power supply device that is shown in FIG. 9. Hence, some of the same reference characters are used in FIG. 11 as in FIG. 9.

Unlike in FIG. 9 a contact head 5 from FIG. 11 is not connected to a rod system 11 via a base plate 19 and a spring device 14, as are shown by way of example in FIG. 9. Instead, the contact head 5 from FIG. 11 itself has a receiver 25, formed as a recess in the shape of a segment of a sphere, for a ball joint 24, into which the ball joint 24 is introduced.

The ball joint 24 is connected to the rod system 11, and the rod system 11 is connected to a roof of an electric vehicle 10. The contact head 5 is connected to the rod system 11 to form a current collector.

Furthermore, a guide device 26 is connected in a ball-and-socket manner to the contact head 5 and in a ball-and-socket manner to the vehicle 10. The guide device 26 comprises a bar-shaped first guide rod system 27 and a bar-shaped second guide rod system (not visible in FIG. 11). The first guide rod system 27 is configured to be adjustable in length and has a first guide rod 28 and a second guide rod 29, which are configured to be displaceable relative to one another in the direction of a shared longitudinal axis of the rod system. A reset spring 30 of the guide device 26 is arranged between the first guide rod 28 and the second guide rod 29 of the first guide rod system 27.

The second guide rod system is configured structurally the same as the first guide rod system 27.

The guide device 26 supports the contact head 5 and due to the reset spring 30 straightens it up again after rotational deflections, which are possible due to the ball joint 24.

FIG. 12 shows a schematic side view of exemplary embodiments of an electric vehicle 10 configured as an electric bus, and a vehicle infrastructure 12, configured as a charging station, with an exemplary embodiment of an inventive power supply device.

The power supply device comprises a contact head 5, which is connected to a rod system 11 to form a charge current collector. The rod system 11 is connected to a roof of the vehicle 10.

The vehicle infrastructure 12 has a docking station 9 that is mechanically and electrically connected to a charge column 31, supplied with power from a power network, of the vehicle infrastructure 12.

Accumulators of the vehicle 10 are charged in a stopping place due to a mechanical and electrical connection between the contact head 5 and the docking station 9. Charge current is transmitted from the docking station 9 into the accumulators via the contact head 5 and the rod system 11.

The contact head 5 and the docking station 9 are configured as described in connection with FIG. 1.

In accordance with the invention, it is also conceivable for the vehicle 10 to be configured not as an electric bus, but as an electric heavy goods vehicle, etc.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

The invention claimed is:

1.-13. (canceled)

14. A power supply device for a vehicle, comprising:
at least one contact head which is connectable to a vehicle and which contactable with a stationary docking station to establish an electrical connection;
a contact head roll mechanism rotatably connected to the at least one contact head and connected so as to be contactable with the docking station, the contact head roll mechanism including at least two rolls or at least two rollers, via which a rolling contact is established between the at least one contact head and the docking station; and
a first roll or a first roller arranged on a first flank of the at least one contact head and a second roll or a second roller arranged on a second flank, opposite the first flank, of the at least one contact head.

15. The power supply device as claimed in claim 14, further comprising:
a docking roll device, with which the at least one contact head is brought into contact, the a docking roll device being rotatably connected to the docking station.

16. The power supply device as claimed in claim 14, wherein the docking station is formed as a contact hood into which the at least one contact head is introducible.

17. The power supply device as claimed in claim 15, wherein the docking station is formed as a contact hood into which the at least one contact head is introducible.

18. The power supply device as claimed in claim 14, further comprising:
a spring device, via which the at least one contact head is connected to the vehicle, the spring device being connected to the at least one contact head.

19. The power supply device as claimed in claim 15, further comprising:
a spring device, via which the at least one contact head is connected to the vehicle, the spring device being connected to the at least one contact head.

20. The power supply device as claimed in claim 16, further comprising:
a spring device, via which the at least one contact head is connected to the vehicle, the spring device being connected to the at least one contact head.

21. The power supply device as claimed in claim 18, wherein the spring device is connected to an underside or an upper side of the at least one contact head.

22. The power supply device as claimed in claim 18, wherein the spring device is laterally connected to the at least one contact head.

23. The power supply device as claimed in claim 21, wherein the spring device is laterally connected to the at least one contact head.

24. The power supply device as claimed in claim 14, wherein the at least one contact head includes a receiver for a ball joint, via which one of (i) the at least one contact head can be connected to the vehicle and (ii) the receiver is connected to the at least one contact head.

25. The power supply device as claimed in claim 24, wherein the receiver is shaped as a segment of a sphere.

26. The power supply device as claimed in claim 24, further comprising:
a length-adjustable guide device, via which the at least one contact head is connectable to the vehicle, said length-adjustable guide device being connected in an articulated and sprung manner to the at least one contact head.

27. The power supply device as claimed in claim 14, wherein the at least one contact head is connected to a rod system, via which the at least one contact head can be connected to the vehicle, to form a current collector.

28. The power supply device as claimed in claim 27, wherein the at least one contact head has at least three degrees of freedom of movement relative to the rod system.

29. The power supply device as claimed in claim 14, wherein the at least one contact head is connected to a rod system, via which the at least one contact head can be connected to the vehicle, to form a current collector; and wherein the at least one contact head has six degrees of freedom of movement relative to the rod system.

30. The power supply device as claimed in claim 14, wherein the vehicle is a utility vehicle such as an electric bus or an electric heavy goods vehicle.

31. The power supply device as claimed in claim 30, wherein the utility vehicle is an electric bus or an electric heavy goods vehicle.

32. A vehicle with the power supply device as claimed in claim 14.

33. A vehicle infrastructure with the power supply device as claimed in claim 14.
